(19) United States
(12) Patent Application Publication
(10) Pub. No.: US 2025/0382222 A1
(43) Pub. Date: Dec. 18, 2025

(54) ETCHING DEVICE AND METHOD OF MANUFACTURING WINDOW

(71) Applicant: Samsung Display Co., LTD., Yongin-si, Gyeonggi-do (KR)

(72) Inventors: BYOUNGYUL SHIM, Yongin-si, Gyeonggi-do (KR); HYUNCHUL KIM, Yongin-si, Gyeonggi-do (KR); KANG DUK CHOI, Yongin-si, Gyeonggi-do (KR)

(21) Appl. No.: 19/193,148

(22) Filed: Apr. 29, 2025

(30) Foreign Application Priority Data
Jun. 14, 2024 (KR) 10-2024-0077780

(51) Int. Cl. C03C 15/00

(52) U.S. Cl. CPC C03C 15/00

(57) ABSTRACT

An etching device includes a stage on which a target substrate is disposed, a nozzle part disposed to face the stage with the target substrate interposed therebetween and spraying an etching solution toward the stage, and a mask part including a first layer provided with a first opening defined therethrough and a second layer disposed on the first layer and provided with a second opening defined therethrough to overlap the first opening in a plan view. The first layer includes a material etched by the etching solution.

This application claims priority to Korean Patent Application No. 10-2024-0077780, filed on Jun. 14, 2024, and all the benefits accruing therefrom under 35 U.S.C. § 119, the content of which in its entirety is herein incorporated by reference.

### BACKGROUND

### 1. Field

The disclosure relates to an etching device and a method of manufacturing a window. More particularly, the disclosure relates to an etching device used to manufacture a foldable window and a method of manufacturing the foldable window.

### 2. Description of Related Art

A display device includes a display area that is activated in response to electrical signals. The display device senses an input applied thereto from the outside through the display area and displays images to provide a user with information through the display area. In recent years, the display devices of a variety of shapes are being developed, and particularly, researches on foldable display devices are actively being conducted. Accordingly, an efficient etching method for an ultra-thin glass (“UTG”) is being desired to implement foldable properties.

### SUMMARY

The disclosure provides an etching device capable of manufacturing a foldable window with improved reliability.

The disclosure provides a method of manufacturing the foldable window with improved reliability through a simplified process.

An embodiment of the inventive concept provides an etching device including a stage on which a target substrate is disposed, a nozzle part disposed to face the stage with the target substrate interposed therebetween and spraying an etching solution toward the stage, and a mask part disposed between the target substrate and the nozzle part and including a first layer provided with a first opening defined therethrough and a second layer disposed on the first layer and provided with a second opening defined therethrough to overlap the first opening in a plan view. The first layer includes a material etched by the etching solution.

In an embodiment, the etching solution may include a fluorinated compound.

In an embodiment, the etching solution may further include a nitric acid.

In an embodiment, the first layer may include at least one of silicon oxide and a metal element, and the second layer includes at least one of amorphous silicon and polysilicon.

In an embodiment, the first layer may include titanium.

In an embodiment, the second opening may completely penetrate through the second layer.

In an embodiment, the second opening may have a size that is substantially equal to a size of the first opening in the plan view.

In an embodiment, the second layer may be disposed directly on the first layer.

An embodiment of the inventive concept provides a method of manufacturing a window. The method includes placing a target substrate on a stage, placing a preliminary first layer including a first etch portion on the target substrate, placing a preliminary second layer, which includes a second etch portion overlapping the first etch portion in a plan view, on the preliminary first layer, etching the second etch portion to form a second layer through which a second opening is defined to expose the first etch portion, and spraying an etching solution toward the stage through a nozzle part disposed to face the stage with the target substrate interposed therebetween to form the window. Each of the preliminary first layer and the target substrate includes a material etched by the etching solution.

In an embodiment, the method may further include etching the first etch portion to form a first layer through which a first opening is defined to expose a portion of the target substrate between the forming the second layer and the forming the window.

In an embodiment, the second opening may have a size that is substantially equal to a size of the first opening in the plan view.

In an embodiment, the second layer may be disposed directly on the first layer.

In an embodiment, the method may further include removing the second layer between the forming the first layer and the forming the window.

In an embodiment, the removing the second layer may include a dry etch or wet etch process.

In an embodiment, the preliminary first layer may include at least one of silicon oxide and a metal element, and the preliminary second layer may include at least one of amorphous silicon and polysilicon

In an embodiment, the method may further include placing a preliminary third layer including a third etch portion overlapping the target substrate in the plan view on the preliminary first layer between the placing the preliminary first layer on the target substrate and the placing of the preliminary second layer on the preliminary first layer. The forming the second layer may include etching the third etch portion to form a third layer through which a third opening is defined to exposed the second etch portion, and the preliminary third layer may be disposed between the preliminary first layer and the preliminary second layer.

In an embodiment, the method further may include removing the second layer between the forming the second layer and the forming the window.

In an embodiment, the preliminary first layer may include titanium, the preliminary second layer may include photoresist, and the preliminary third layer may include at least one of amorphous silicon and polysilicon.

In an embodiment, the window may include a first non-folding portion, a second non-folding portion spaced apart from the first non-folding portion in the plan view, and a folding portion disposed between the first non-folding portion and the second non-folding portion, and the folding portion may have a thickness smaller than each of a thickness of the first non-folding portion and a thickness of the second non-folding portion.

In an embodiment, a difference between the thickness of the folding portion and each of the thickness of the first non-folding portion and the thickness of the second non-folding portion may be smaller than about 7 micrometers.

According to the above, the etching device is able to manufacture the window with foldable characteristics and improved reliability through a simple process using the first layer that includes a material dissolved in the etching solution.

According to the above, the window with foldable characteristics and improved reliability is manufactured through a simple process using the first layer that includes a material dissolved in the etching solution, and thus, the process difficulty is improved.

### BRIEF DESCRIPTION OF THE DRAWINGS

The above and other advantages of the disclosure will become readily apparent by reference to the following detailed description when considered in conjunction with the accompanying drawings, in which:

FIGS. 1A to 1C are perspective views of an embodiment of a display device according to the disclosure;

FIG. 2 is an exploded perspective view of an embodiment of a display device according to the disclosure;

FIG. 3 is a cross-sectional view of a display device taken along line I-I′ of FIG. 2;

FIG. 4 is a perspective view of an embodiment of an etching device according to the disclosure;

FIGS. 5 and 6 are cross-sectional views of an embodiment of an etching device according to the disclosure;

FIG. 7 is a flowchart illustrating an embodiment of a method of manufacturing a window according to the disclosure; and

FIGS. 8 to 20 are views of an embodiment of a method of manufacturing a window according to the disclosure.

### DETAILED DESCRIPTION

In the disclosure, it will be understood that when an element (or area, layer, or portion) is referred to as being “on”, “connected to” or “coupled to” another element or layer, it may be directly on, connected or coupled to the other element or layer or intervening elements or layers may be present.

Like numerals refer to like elements throughout. In the drawings, the thickness, ratio, and dimension of components are exaggerated for effective description of the technical content. As used herein, the term “and/or” may include any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the teachings of the disclosure. As used herein, the singular forms, “a”, “an” and “the” are intended to include the plural forms as well, unless the context clearly indicates otherwise.

Spatially relative terms, such as “beneath”, “below”, “lower”, “above”, “upper” and the like, may be used herein for ease of description to describe one element or feature's relationship to another elements or features as shown in the drawing figures.

It will be further understood that the terms “include” and/or “including”, when used in this specification, specify the presence of stated features, integers, steps, operations, elements, and/or components, but do not preclude the presence or addition of one or more other features, integers, steps, operations, elements, components, and/or groups thereof.

In the disclosure, when an element is referred to as being “directly connected” to another element, there are no intervening elements between a layer, film, region, or substrate and another layer, film, region, or substrate. For example, the term “directly connected” may mean that two layers or two members are disposed without employing additional adhesive therebetween.

“About” or “substantially” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term “about” or “substantially” can mean within one or more standard deviations, or within +30%, 20%, 10%, 5% of the stated value, for example.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the disclosure will be described with reference to accompanying drawings.

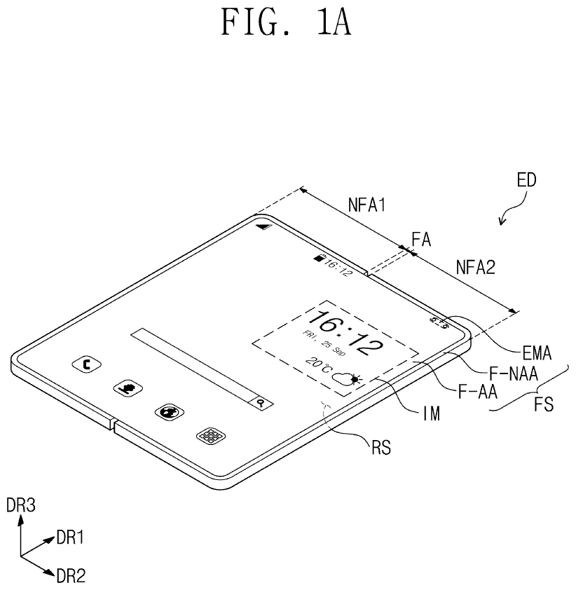

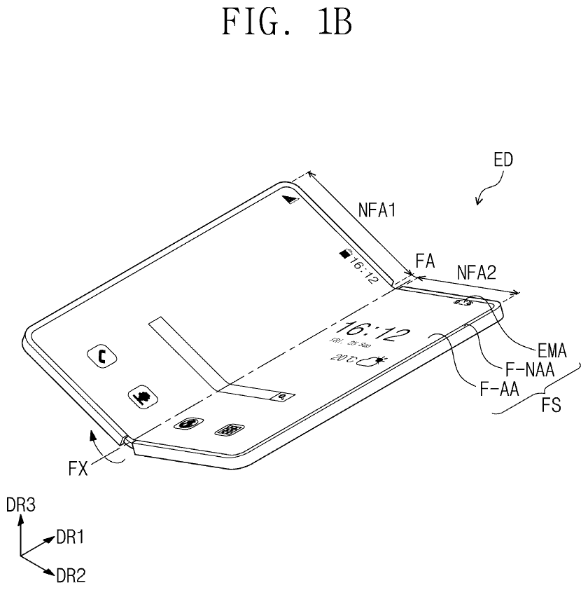

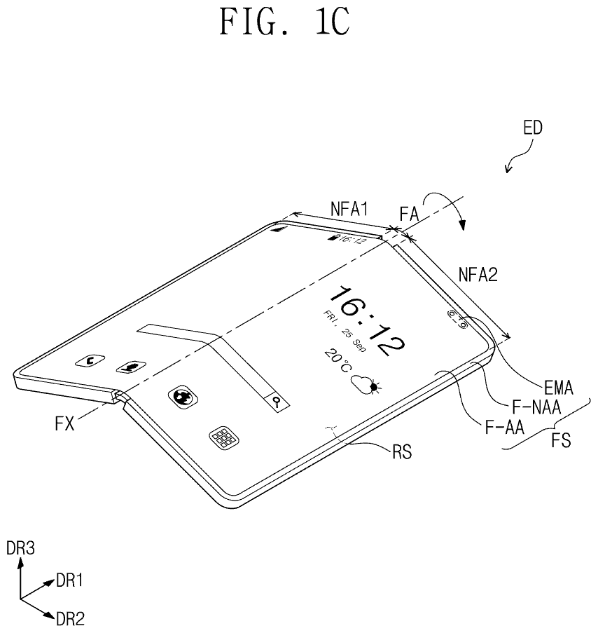

FIGS. 1A to 1C are perspective views of an embodiment of a display device ED according to the disclosure. FIG. 1A shows an unfolded state of the display device ED, and FIGS. 1B and 1C show a folded state of the display device ED.

FIGS. 1A to 1C show a foldable display device as the display device ED, however, the disclosure should not be limited thereto or thereby. The display device ED may be a flexible display device that is bendable or rollable.

The display device ED may include a display surface FS defined by a first directional axis DR1 and a second directional axis DR2 intersecting the first directional axis DR1. The display device ED may provide an image IM to a user through the display surface FS. The display device ED may display the image IM through the display surface FS, which is substantially parallel to each of the first directional axis DR1 and the second directional axis DR2, toward a third directional axis DR3.

The display surface FS of the display device ED may include an active area F-AA and a peripheral area F-NAA. The active area F-AA of the display device ED may be activated in response to electrical signals. The display device ED may display the image IM through the active area F-AA. In addition, various external inputs may be sensed through the active area F-AA. The peripheral area F-NAA may be defined next (adjacent) to the active area F-AA. The peripheral area F-NAA may have a predetermined color. The peripheral area F-NAA may surround the active area F-AA. Accordingly, the active area F-AA may have a shape that is substantially defined by the peripheral area F-NAA, however, this is merely one of embodiments. The peripheral area F-NAA may be defined next (adjacent) to only one side of the active area F-AA or may be omitted. In an embodiment, the display device ED may include the active area of various shapes, and it should not be particularly limited.

The active area F-AA may include a sensing area EMA. Various electronic modules may be disposed in the sensing area EMA. In an embodiment, the electronic module may include at least one of a camera module, a speaker, an optical sensor, and a thermal sensor. An external object may be sensed through the sensing area EMA of the display surface FS, or a sound signal, such as a voice, may be provided to the outside through the sensing area EMA of the display surface FS. In addition, the electronic module may include a plurality of components, and it should not be limited to a particular embodiment.

The sensing area EMA may be surrounded by the active area F-AA and the peripheral area F-NAA, however, it should not be limited thereto or thereby. The sensing area EMA may be defined in the active area F-AA, and it should not be particularly limited. FIG. 1A shows one sensing area EMA as an illustrative embodiment, however, the number of the sensing areas EMA should not be limited thereto or thereby.

The sensing area EMA may be a portion of the active area F-AA. Accordingly, the display device ED may also display an image through the sensing area EMA. When the electronic modules disposed in the sensing area EMA are deactivated, the sensing area EMA may serve as the display surface to display the image.

The display device ED may include a rear surface RS facing the display surface FS. The rear surface RS may be an external surface of the display device ED, and the image may not be displayed through the rear surface RS, however, it should not be limited thereto or thereby. In an embodiment, the rear surface RS may serve as a second display surface through which the image is displayed. In addition, although not shown in drawing figures, the display device ED may further include a sensing area defined in the rear surface RS. A camera, a speaker, and an optical sensor may be disposed in the sensing area defined in the rear surface RS.

The display device ED may include a folding area FA and non-folding areas NFA1 and NFA2. The display device ED may include a plurality of non-folding areas NFA1 and NFA2. According to the illustrated embodiment, the display device ED may include first and second non-folding areas NFA1 and NFA2 disposed next (adjacent) to each other with the folding area FA interposed therebetween. FIGS. 1A to 1C show the display device ED including one folding area FA, however, the disclosure should not be limited thereto or thereby. In an embodiment, the display device ED may include a plurality of folding areas defined therein. In an embodiment, the display device ED may be folded with respect to a plurality of folding axes to allow portions of the display surface FS to face each other, and the number of the folding axes and the number of the non-folding areas should not be particularly limited.

Referring to FIGS. 1B and 1C, the display device ED may be folded with respect to a folding axis FX extending in one direction. The folding axis FX shown in FIGS. 1B and 1C may be an imaginary axis extending in the first directional axis DR1 to be substantially parallel to a direction in which a long side of the display device ED extends. However, the direction in which the folding axis FX extends should not be limited to the first directional axis DR1.

The folding axis FX may extend in the first directional axis DR1 on the display surface FS or may extend in the first directional axis DR1 under the rear surface RS. Referring to FIG. 1B, the display device ED may be inwardly folded (in-folding) to allow the first non-folding area NFA1 and the second non-folding area NFA2 to face each other, and thus, the display surface FS may not be exposed to the outside. In addition, referring to FIG. 1C, the display device ED may be outwardly folded (out-folding) with respect to the folding axis FX to allow a portion of the rear surface RS, which overlaps the first non-folding area NFA1, to face a remaining (the other) portion of the rear surface RS, which overlaps the second non-folding area NFA2.

The display device ED may repeat the unfolding operation and the in-folding operation or to repeat the unfolding operation and the out-folding operation, however, the disclosure should not be limited thereto or thereby. In an embodiment, the display device ED may be selectively operated in any one of the unfolding operation, the in-folding operation, and the out-folding operation.

, FIGS. 1A to 1C show the display device ED folded with respect to the folding axis FX substantially parallel to the long side of the display device ED, however, the disclosure should not be limited thereto or thereby. In an embodiment, the display device ED may be folded with respect to a folding axis substantially parallel to a short side of the display device ED.

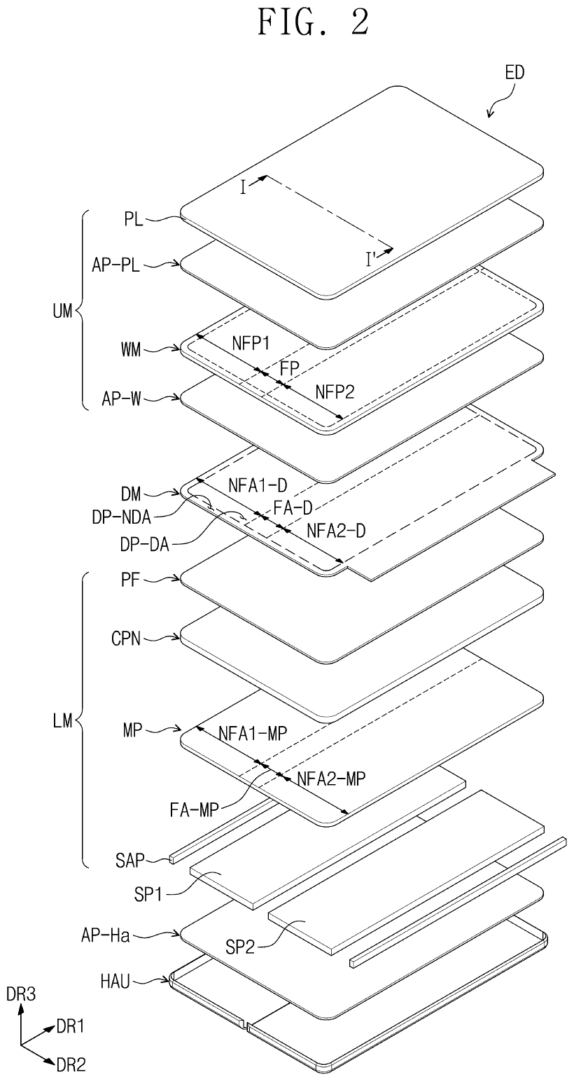

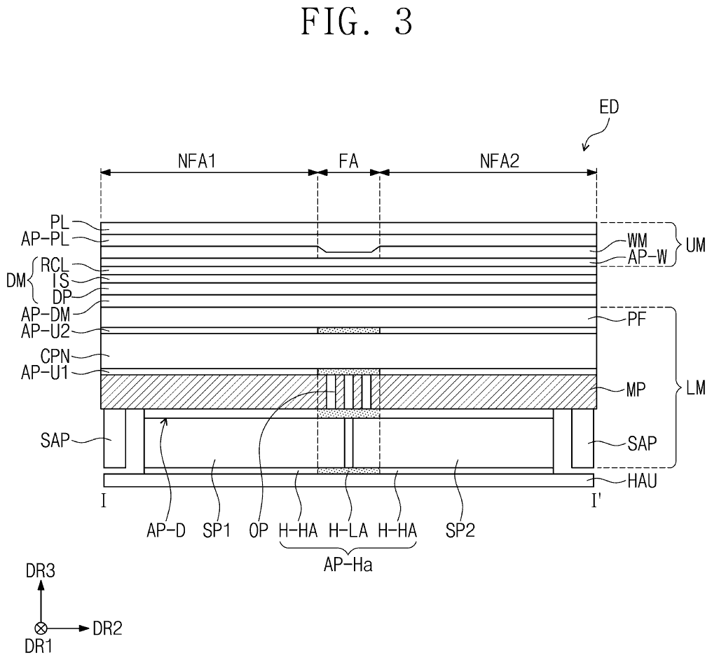

FIG. 2 is an exploded perspective view of an embodiment of the display device ED according to the disclosure. FIG. 3 is a cross-sectional view of the display device ED according to the disclosure. FIG. 2 is an exploded perspective view of the display device ED shown in FIG. 1A. FIG. 3 is a cross-sectional view taken along line I-I′ of FIG. 2.

Referring to FIGS. 2 and 3, the display device ED may include a display module DM, an upper module UM disposed above the display module DM, and a lower module LM disposed under the display module DM. In the following descriptions, the upper module UM may be also referred to as a protective member, and the lower module LM may be also referred to as a support member.

The upper module UM disposed above the display module DM may function as a protective part to protect the display module DM from external impacts or may function as an optical part to prevent reflection by external light or to increase light extraction efficiency.

The upper module UM may include a window WM disposed above the display module DM, a protective layer PL disposed above the window WM, and a protective layer adhesive layer AP-PL disposed between the window WM and the protective layer PL.

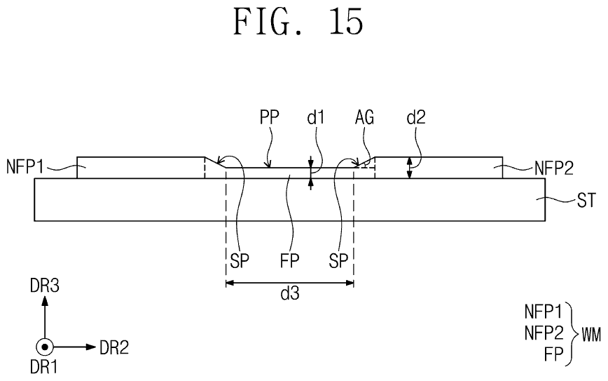

The window WM may cover an entirety of the upper surface of the display module DM. The window WM may have a shape corresponding to a shape of the display module DM. The window WM of the display device ED may include an optically transparent insulating material. The window WM may include a glass substrate or a polymer substrate. In an embodiment, the window WM may be a tempered glass substrate. According to the window WM, a step difference between a folding portion FP and non-folding portions NFP1 and NFP2 may be reduced, and thus, a distortion in image between a display area DP-DA and a non-display area DP-NDA of the display device ED may be improved. The shape of the window WM will be described in detail with reference to FIG. 15.

In addition, the upper module UM may further include a window adhesive layer AP-W disposed under the window WM. The window adhesive layer AP-W may be disposed between the display module DM and the window WM. The window adhesive layer AP-W may be an optically clear adhesive (“OCA”) film or an optically clear adhesive resin (“OCR”) layer. In an embodiment, the window adhesive layer AP-W may be omitted.

The protective layer PL may be disposed above the window WM and may protect the window WM from external environments. The protective layer PL may be transparent, and thus, image information provided from the display module DM may be viewed even though the protective layer PL is disposed. The protective layer PL may be an uppermost surface of the display device ED to be exposed, and the protective layer PL may be damaged depending on the use of the display device ED.

The protective layer PL may have an optical characteristic having a transmittance of about 90% or more in a visible light region and a haze value of less than about 1%. The protective layer PL may include a polymer film. In addition, the protective layer PL may have a polymer film as a base layer and may further include a functional layer such as a hard coating layer, an anti-fingerprint coating layer, an antistatic coating layer, or the like on the base layer. The protective layer PL used in the display device ED may have flexibility.

The protective layer PL may be a polymer film including at least one polymer resin among polyethylene terephthalate (“PET”), polybutylene terephthalate (“PBT”), polyethylene naphthalene (“PEN”), polycarbonate (“PC”), polymethylmethacrylate (“PMMA”), polystyrene (“PS”), polyvinylchloride (“PVC”), polyethersulfone (“PES”), polypropylene (“PP”), polyamide (“PA”), modified polyphenylene ether (“m-PPO”), polyoxymethylene (“POM”), polysulfone (“PSU”), polyphenylene sulfide (“PPS”), polyimide (“PI”), polyethyleneimine (“PEI”), polyether ether ketone (“PEEK”), polyamide imide (“PAI”), polyarylate (“PAR”), and thermoplastic polyurethane (“TPU”).

In an embodiment, the protective layer PL may be a polyethylene terephthalate (“PET”) film or a TPU film. In addition, the protective layer PL may be a PET film without a phase delay.

According to the display device ED, the protective layer adhesive layer AP-PL may be disposed between the window WM and the protective layer PL. The protective layer adhesive layer AP-PL may be an optically clear adhesive layer. The protective layer adhesive layer AP-PL may be attached to the window WM to fix the protective layer PL to the window WM.

The display device ED in an embodiment may include a housing HAU that accommodates the display module DM and the lower module LM. The housing HAU may be coupled to the window WM. Although not shown, the housing HAU may further include a hinge structure for easy folding or bending. The hinge structure may be disposed to correspond to (e.g., overlapping a portion or an entirety of) the folding area FA.

The display device ED in an embodiment may include a housing adhesive layer AP-Ha. The housing adhesive layer AP-Ha may function to fix the lower module LM to the housing HAU. The housing adhesive layer AP-Ha may include a folding adhesive portion H-LA corresponding to the folding area FA and non-folding adhesive portions H-HA corresponding to the non-folding areas NFA1 and NFA2. The housing adhesive layer AP-Ha may be an adhesive member to allow the lower module LM to be coupled to the housing HAU and may also function as an electromagnetic shielding layer or a heat dissipation layer.

The window WM may include a window folding portion FP and window non-folding portions NFP1 and NFP2. A first non-folding portion NFP1 and a second non-folding portion NFP2 of the window WM may be spaced apart from each other with the folding portion FP interposed therebetween. The folding portion FP may correspond to the folding area FA (refer to FIG. 1A), and the non-folding portions NFP1 and NFP2 may correspond to the non-folding areas NFA1 and NFA2 (refer to FIG. 1A), respectively. The shape of the window WM will be described in detail later.

The display module DM included in the display device ED may generate an image and may sense an input applied thereto from the outside. The display module DM may include a display panel DP and an input sensor IS disposed on the display panel DP. In addition, the display module DM may further include an optical layer RCL disposed on the input sensor IS.

The display panel DP may have a configuration that substantially generates the image. The display panel DP may be a light emitting type display panel. In an embodiment, the display panel DP may be an organic light emitting display panel, an inorganic light emitting display panel, a quantum dot display panel, a micro-light-emitting diode (“micro-LED”) display panel, or a nano-LED display panel, for example. The display panel DP may be also referred to as a display layer.

The input sensor IS may be disposed on the display panel DP. The input sensor IS may sense an external input applied thereto from the outside. The external input may be a user input. The user input may include various forms of external inputs, such as a part of a user's body, light, heat, pen, or pressure.

The input sensor IS may be formed on the display panel DP through successive processes. In this case, the input sensor IS may be expressed as being disposed directly on the display panel DP. The expression that the input sensor IS is disposed directly on the display panel DP may mean that no third component is disposed between the input sensor IS and the display panel DP. That is, a separate adhesive member may not be disposed between the input sensor IS and the display panel DP. In an embodiment, the input sensor IS may be coupled to the display panel DP by an adhesive member. The adhesive member may be a conventional adhesive.

The optical layer RCL may be disposed on the input sensor IS. The optical layer RCL may be an anti-reflective layer to reduce a reflectance of the display module DM with respect to the external light incident into the display module DM. The optical layer RCL may be formed on the input sensor IS through successive processes. The optical layer RCL may include a polarizer or a color filter layer. In an embodiment, the optical layer RCL may include pigments or dyes and may absorb a light in a predetermined wavelength range. When the optical layer RCL includes the color filter layer, the color filter layer may include a plurality of color filters arranged in a predetermined arrangement. In an embodiment, the color filters may be arranged by taking into account colors of lights emitted from pixels included in the display panel DP. In addition, the optical layer RCL may further include a partition pattern to distinguish the pixels of the display panel DP from each other. The partition pattern may include a black pigment or dye. In an embodiment, the optical layer RCL may be omitted.

The display module DM may include the display area DP-DA and the non-display area DP-NDA. The display area DP-DA may be defined as an area in which the image provided from the display module DM is displayed.

The non-display area DP-NDA may be defined next (adjacent) to the display area DP-DA. In an embodiment, the non-display area DP-NDA may surround the display area DP-DA, however, this is merely one of embodiments. In an embodiment, the non-display area DP-NDA may have various shapes and should not be particularly limited. The display area DP-DA of the display module DM may correspond to at least a portion of the active area F-AA (refer to FIG. 1A).

According to the display device ED, the display module DM may include a folding display portion FA-D and non-folding display portions NFA1-D and NFA2-D. The folding display portion FA-D may correspond to the folding area FA (refer to FIG. 1A), and the non-folding display portions NFA1-D and NFA2-D may correspond to the non-folding areas NFA1 and NFA2 (refer to FIG. 1A), respectively.

The folding display portion FA-D may be folded or bent with respect to the folding axis FX (refer to FIG. 1A). The display module DM may include a first non-folding display portion NFA1-D and a second non-folding display portion NFA2-D, and the first non-folding display portion NFA1-D and the second non-folding display portion NFA2-D may be spaced apart from each other with the folding display portion FA-D interposed therebetween.

The display device ED may further include a module adhesive layer AP-DM disposed between the display module DM and the lower module LM. The module adhesive layer AP-DM may be an optically clear adhesive (“OCA”) film or an optically clear adhesive resin (“OCR”) layer.

According to the display device ED, the lower module LM may include a support plate MP and adhesive layers AP-U1, AP-U2, and AP-D disposed on and under the support plate MP. In addition, the lower module LM may include at least one of support portions SP1 and SP2, a filling portion SAP, a module protective layer PF, and a buffer layer CPN. In an embodiment, the display device ED may include the support plate MP disposed under the display module DM, the module protective layer PF and the buffer layer CPN disposed between the support plate MP and the display module DM, and the support portions SP1 and SP2 and the filling portion SAP disposed under the support plate MP.

The support plate MP may be disposed under the display module DM. The support plate MP may include a folding support portion FA-MP and non-folding support portions NFA1-MP and NFA2-MP. In the following descriptions, the folding support portion FA-MP may be also referred to as a folding portion, and the non-folding support portions NFA1-MP and NFA2-MP may be also referred to as non-folding portions. A first non-folding portion NFA1-MP and a second non-folding portion NFA2-MP of the support plate MP may be spaced apart from each other with the folding portion FA-MP interposed therebetween. The folding portion FA-MP may correspond to the folding area FA, and the non-folding portions NFA1-MP and NFA2-MP may correspond to the non-folding areas NFA1 and NFA2, respectively.

The support plate MP may include a metal material or polymer material. In an embodiment, the support plate MP may include stainless steel, aluminum, or any alloys thereof. In addition, in an embodiment, the support plate MP may include a carbon fiber reinforced plastic (“CFRP”), however, the disclosure should not be limited thereto or thereby. In an embodiment, the support plate MP may include at least one of a non-metallic material, a plastic material, a glass fiber reinforced plastic, or a glass material.

The support plate MP may be provided with a plurality of openings OP defined therethrough. The openings OP may be defined to correspond to the folding area FA.

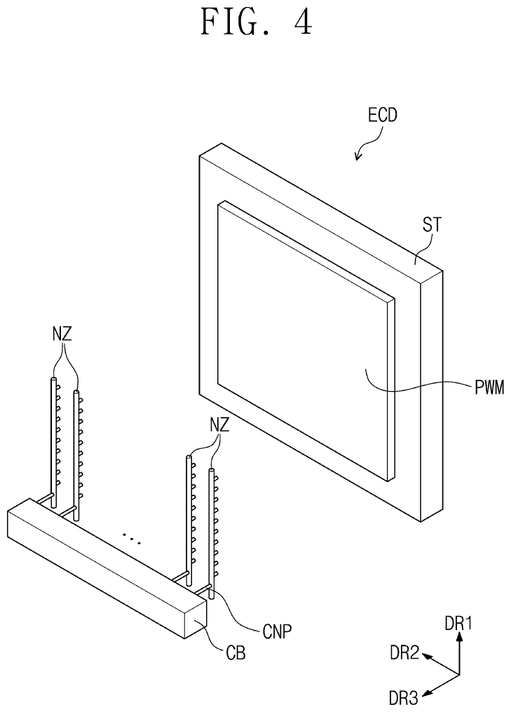

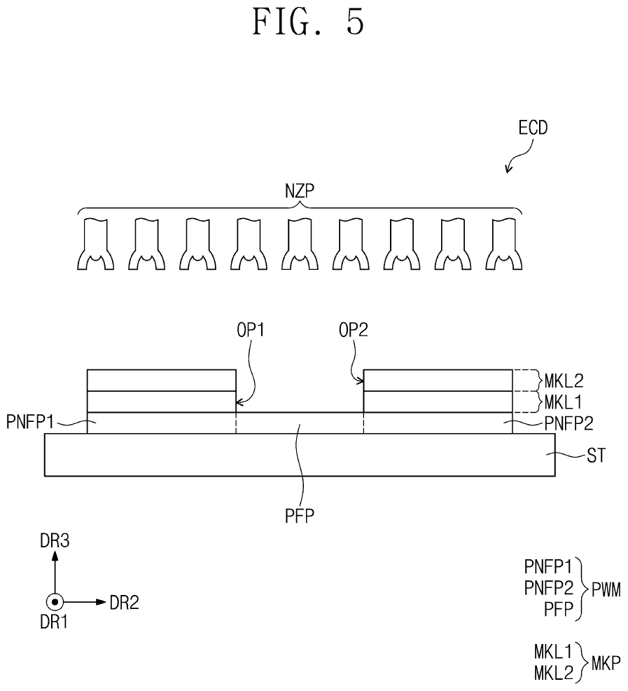

Referring to FIGS. 4 and 5, the module protective layer PF may be disposed between the display module DM and the support plate MP. The module protective layer PF may be disposed under the display module DM and may protect a rear surface of the display module DM. The module protective layer PF may cover an entirety of the display module DM. The module protective layer PF may include a polymer material. In an embodiment, the module protective layer PF may be a polyimide film or a polyethylene terephthalate film, however, materials for the module protective layer PF should not be limited thereto or thereby.

The display device ED may include the support portions SP1 and SP2 and the filling portion SAP. The support portions SP1 and SP2 may overlap most of the display module DM. The filling portion SAP may be disposed outside the support portions SP1 and SP2 and may overlap an outer portion of the display module DM.

The support portions SP1 and SP2 may include a first sub-support portion SP1 and a second sub-support portion SP2 spaced apart from the first sub-support portion SP1 in the first directional axis DR1. The first sub-support portion SP1 and the second sub-support portion SP2 may be spaced apart from each other in an area corresponding to the folding axis FX (refer to FIG. 1A). As the support portions SP1 and SP2 are provided as the first sub-support portion SP1 and the second sub-support portion SP2 that are spaced apart from each other in the folding area FA, the folding or bending characteristics of the display device ED may be improved. Although not shown in drawing figures, the lower module LM may further include a cushion layer (not shown) disposed on or under the support portions SP1 and SP2. The cushion layer (not shown) may include sub-cushion layers separated from each other in an area corresponding to the folding axis FX (refer to FIG. 1A). A lower adhesive layer in which an adhesive force in an area corresponding to the folding area FA is smaller than an adhesive force in an area corresponding to the non-folding areas NFA1 and NFA2 may be further disposed between the support portions SP1 and SP2 and the cushion layer (not shown). The lower adhesive layer may include a polymer compound including a polymer backbone and a plurality of cross-linking units.

The cushion layer (not shown) may prevent the support plate MP from being pressed and deformed by external impact and force. The cushion layer (not shown) may include a sponge, a foam, or an elastomer such as a urethane resin. In addition, the cushion layer (not shown) may include at least one of an acrylic-based polymer, a urethane-based polymer, a silicon-based polymer, and an imide-based polymer, however, it should not be limited thereto or thereby. In an embodiment, the cushion layer (not shown) may be disposed under the support plate MP or under a lower support plate (not shown).

The filling portion SAP may be disposed outside the support portions SP1 and SP2. The filling portion SAP may be disposed between the support plate MP and the housing HAU. The filling portion SAP may be filled in a space between the support plate MP and the housing HAU to fix the support plate MP.

Referring to FIG. 3, the display device ED may include the buffer layer CPN included in the lower module LM. The buffer layer CPN may serve as a thickness compensation layer to compensate for the difference in thickness of the components disposed under the display module DM or a support layer to support the display module DM. Unlike illustrated, in an embodiment, the buffer layer CPN may be omitted.

A combination of components included in the lower module LM in the display device ED should not be limited thereto or thereby and may vary depending on the size, shape, and operating characteristics of the display device ED. In an embodiment, the lower module LM may further include additional components, such as a support plate, a cushion member, an adhesive layer, or the like, or some of the components of the lower module LM shown in FIGS. 4 and 5 may be omitted.

The lower module LM of the display device ED may include one or more upper adhesive layers AP-U1 and AP-U2 disposed above the support plate MP and at least one lower adhesive layer AP-D disposed under the support plate MP.

At least one of the adhesive layers AP-U1, AP-U2, and AP-D included in the lower module LM may include a polymer compound including a polymer backbone and a plurality of cross-linking units. At least one of the adhesive layers AP-U1, AP-U2, and AP-D included in the lower module LM may have an adhesive force that is smaller in an area corresponding to the folding area FA than in an area corresponding to the non-folding areas NFA1 and NFA2. The adhesive layers AP-U1, AP-U2, and AP-D including the polymer compound may include a portion whose adhesive force decreases by providing an ultraviolet light with a wavelength of about 280 nanometers (nm) or less, and thus, a bending deformation may be reduced during the folding operation of the display device ED. In addition, the adhesive force of a portion where the ultraviolet light with a wavelength of 280 nm or less is not provided may be maintained, and thus, an adhesive strength of members next (adjacent) to the adhesive layers AP-U1, AP-U2, and AP-D may be maintained by the adhesive layers AP-U1, AP-U2, and AP-D.

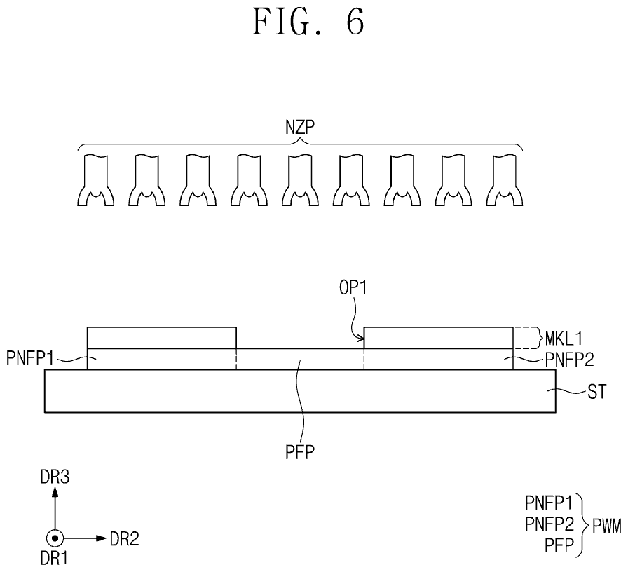

FIG. 4 is a perspective view of an embodiment of an etching device ECD according to the disclosure. FIGS. 5 and 6 are cross-sectional views of an embodiment of the etching device ECD according to the disclosure. The etching device ECD is used to manufacture the window WM described with reference to FIG. 2. FIGS. 5 and 6 show a cross-section of the etching device ECD shown in FIG. 4. FIG. 6 shows a state in which a second layer MKL2 is etched in a configuration of the etching device ECD of FIG. 5.

Referring to FIGS. 4 and 5, the etching device ECD may include a stage ST, a nozzle part NZP, and a mask part MKP.

A target substrate PWM may be disposed on the stage ST. The stage ST may provide a base surface to which the target substrate PWM is fixed. The stage ST may include an acid-resistance material. The acid-resistance material may include plastic. The stage ST may include or consist of plastic. The stage ST may not be etched by an etching solution described later. Different from the etching device ECD shown in FIG. 5, the stage ST may be relatively large enough to accommodate multiple target substrates PWM thereon. The target substrate PWM may be the window WM (refer to FIG. 2) described above according to the use of the etching device ECD of the disclosure. The target substrate PWM may include a first preliminary non-folding portion PNFP1, a second preliminary non-folding portion PNFP2 spaced apart from the first preliminary non-folding portion PNFP1 in the plan view, and a preliminary folding portion PFP disposed between the first preliminary non-folding portion PNFP1 and the second preliminary non-folding portion PNFP2 in the plan view. The first preliminary non-folding portion PNFP1 may correspond to the first non-folding area NFA1 (refer to FIG. 1A). The second preliminary non-folding portion PNFP2 may correspond to the second non-folding area NFA2 (refer to FIG. 1A). The preliminary folding portion PFP may correspond to the folding area FA (refer to FIG. 1A).

The nozzle part NZP may be disposed to face the stage ST with the target substrate PWM interposed therebetween and may spray the etching solution to the stage ST. The nozzle part NZP may include a chamber CB, a plurality of connection parts CNP, and a plurality of nozzles NZ. The nozzle part NZP may include an acid-resistance material. The acid-resistance material may include plastic. The nozzle part NZP may include or consist of plastic. The nozzle part NZP may not be etched by the etching solution. The chamber CB may provide a space to store the etching solution. The connection part CNP may be connected to the chamber CB and may serve as a passage to transmit the etching solution to the nozzle NZ. The nozzles NZ may spray the etching solution provided thereto through the connection part CNP toward the stage ST. The etching solution may include a fluorinated compound. In an embodiment, the etching solution may include hydrofluoric acid or ammonium hydrogen fluoride. At least a portion of the target substrate PWM may dissolve by the etching solution. The etching solution may further include nitric acid. When the etching solution further includes nitric acid, an etching rate of the mask part MKP described later may be controlled, and thus, the yield of the method of manufacturing the window may be improved.

The mask part MKP may include a first layer MKL1 and the second layer MKL2 and may be disposed between the target substrate PWM and the nozzle part NZP. The mask part MKP may be disposed on the target substrate PWM and may guide the etching solution sprayed by the nozzle part NZP to be appropriately coated on the target substrate PWM. The mask part MKP may be disposed directly on the target substrate PWM.

The first layer MKL1 may be provided with a first opening OP1 defined therethrough. The first layer MKL1 may include a material that is dissolved in the etching solution. The first layer MKL1 and the target substrate PWM may be substantially simultaneously dissolved by the etching solution. The first layer MKL1 may be disposed on the target substrate PWM and may control the extent and rate at which the target substrate PWM is dissolved by the etching solution. The first layer MKL1 may include at least one of silicon oxide and a metal element. In an embodiment, the first layer MKL1 may include SiO₂ or titanium. The first opening OP1 may completely penetrate through the first layer MKL1. A portion of the target substrate PWM may be exposed through the first opening OP1. The etching solution may be directly provided to one surface of the target substrate PWM through the first opening OP1. When the etching solution is sprayed to the stage ST, the portion of the target substrate PWM, which is exposed through the first opening OP1, may dissolve faster than the rest of the target substrate PWM, which is not exposed through the first opening OP1. The first opening OP1 may overlap the preliminary folding portion PFP in the plan view.

The second layer MKL2 may be disposed on the first layer MKL1 and may be provided with a second opening OP2 defined therethrough to correspond to the first opening OP1 in the plan view. The second layer MKL2 may be disposed directly on the first layer MKL1. The second layer MKL2 may include at least one of photoresist, amorphous silicon, and polysilicon. In an embodiment, the second layer MKL2 may include the photoresist. The second layer MKL2 may not be etched by the etching solution. The second layer MKL2 may guide the etching solution so that a portion of a preliminary first layer PMKL1 (refer to FIG. 11) described later is etched to become the first layer MKL1. The second opening OP2 may completely penetrate through the second layer MKL2. A size of the second opening OP2 in the plan view may bs substantially the same as a size of the first opening OP1 in the plan view.

Referring to FIGS. 5 and 6, the etching solution may be provided onto the second layer MKL2 during the manufacturing process of the window. The second layer MKL2 may be removed by a dry etch or wet etch process. In an embodiment, the second layer MKL2 may be removed by a solution including or consisting of sodium hydroxide. After the second layer MKL2 is removed, the etching solution may be provided to the first layer MKL1 and the portion of the target substrate PWM, which is exposed through the first opening OP1.

The etching device according to the disclosure may be disposed above the target substrate and may provide the etching solution on the mask part through which the portion of the target substrate is exposed to reduce the step difference between the folding portion and the non-folding portion of the window. When the step difference between the folding portion and the non-folding portion of the window is reduced, distortion in image may be reduced, and thus, the reliability of the display device may be improved.

Hereinafter, the manufacturing method of the window using the etching device according to the disclosure will be described, and detailed descriptions of the same components described with reference to FIGS. 1A to 6 will be omitted.

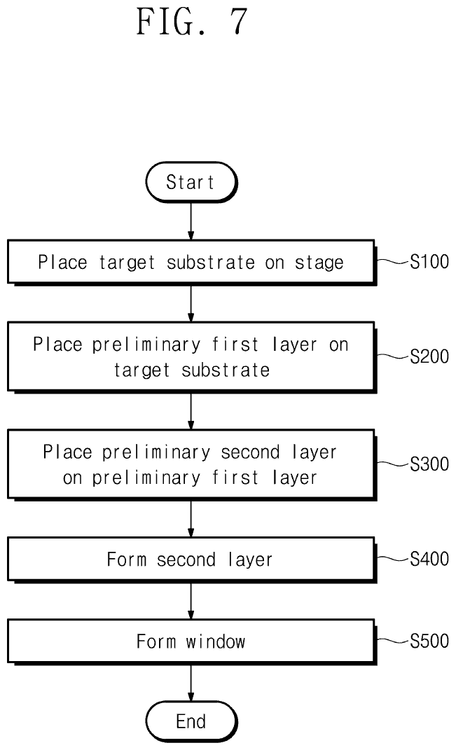

FIG. 7 is a flowchart illustrating the manufacturing method of the window according to the disclosure. FIGS. 8 to 20 are views of the manufacturing method of the window according to the disclosure.

Referring to FIG. 7, the manufacturing method of the window includes placing the target substrate on the stage (S100), placing the preliminary first layer on the target substrate (S200), placing a preliminary second layer on the preliminary first layer (S300), forming the second layer (S400), and forming the window (S500).

Referring to FIG. 8, the target substrate PWM may be disposed directly on the stage ST. The target substrate PWM may include the material etched by the etching solution. The target substrate PWM may include a glass material. Although not shown in drawing figures, the stage ST may further include an additional component to fix the target substrate PWM.

Referring to FIG. 9, the preliminary first layer PMKL1 may include the material etched by the etching solution in the placing of the preliminary first layer PMKL1 on the target substrate PWM. The preliminary first layer PMKL1 may include silicon oxide or metal element. In an embodiment, the preliminary first layer PMKL1 may include SiO₂. The preliminary first layer PMKL1 may be disposed directly on the target substrate PWM. The preliminary first layer PMKL1 may include a first etch portion ECA1. The first etch portion ECA1 may overlap the preliminary folding portion PFP in the plan view. A size of the first etch portion ECA1 in the plan view may be substantially the same as a size of the preliminary folding portion PFP in the plan view.

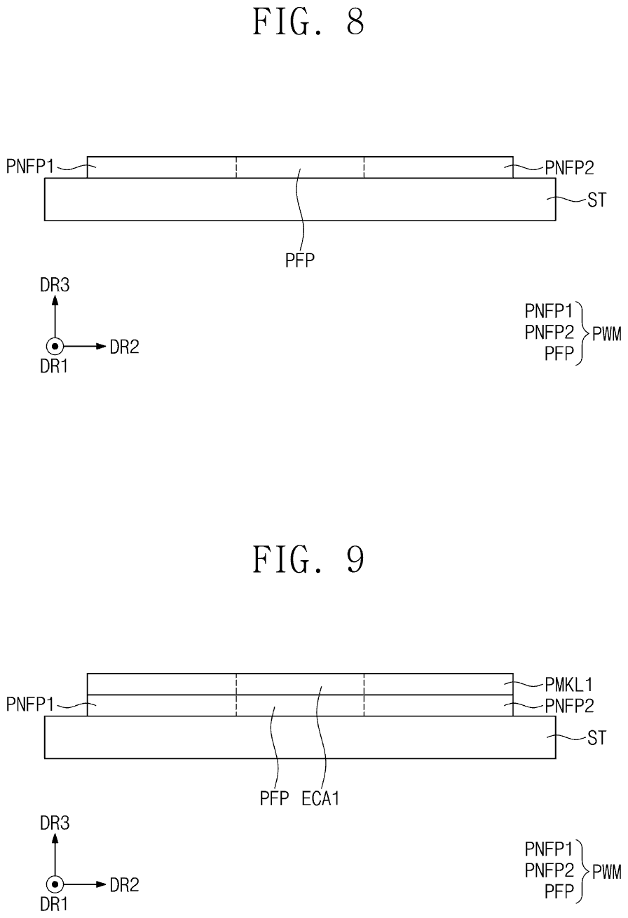

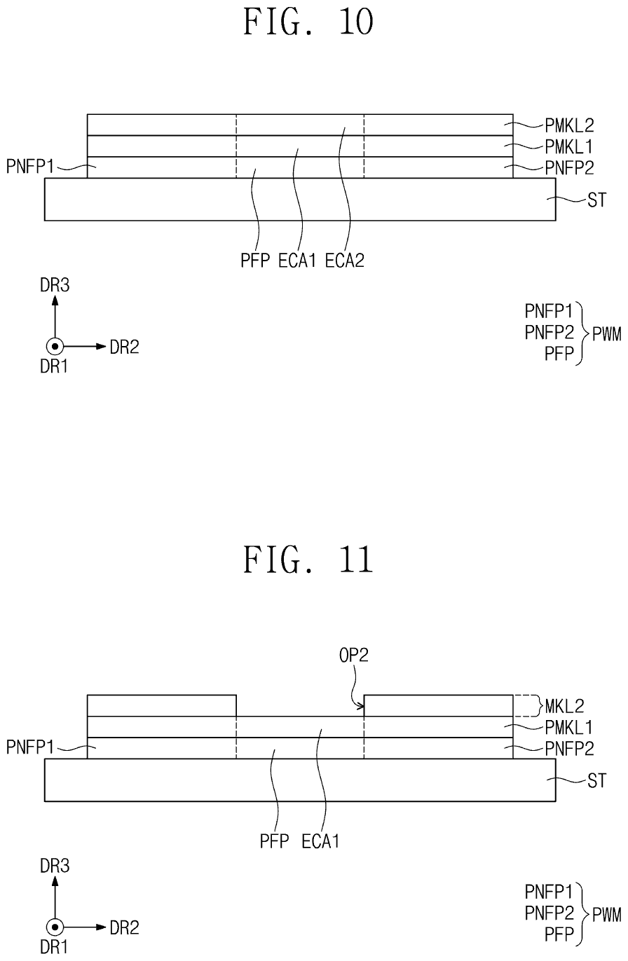

Referring to FIG. 10, the preliminary second layer PMKL2 may include at least one of photoresist, amorphous silicon, and polysilicon in the placing of the preliminary second layer PMKL2 on the preliminary first layer PMKL1. In an embodiment, the preliminary second layer PMKL2 may include photoresist. The preliminary second layer PMKL2 may not be etched by the etching solution. The preliminary second layer PMKL2 may be disposed directly on the preliminary first layer PMKL1. The preliminary second layer PMKL2 may include a second etch portion ECA2 overlapping the first etch portion ECA1 in the plan view. The second etch portion ECA2 may overlap the preliminary folding portion PFP in the plan view. A size of the second etch portion ECA2 in the plan view may be substantially the same as the size of the first etch portion ECA1 in the plan view.

Referring to FIGS. 10 and 11, the second etch portion ECA2 may be etched to form the second layer MKL2 through which the second opening OP2 is defined in the forming of the second layer MKL2. In a case where the preliminary second layer PMKL2 includes a positive photoresist, the etching of the second etch portion ECA2 may include exposing only the second etch portion ECA2 and developing the second etch portion ECA2.

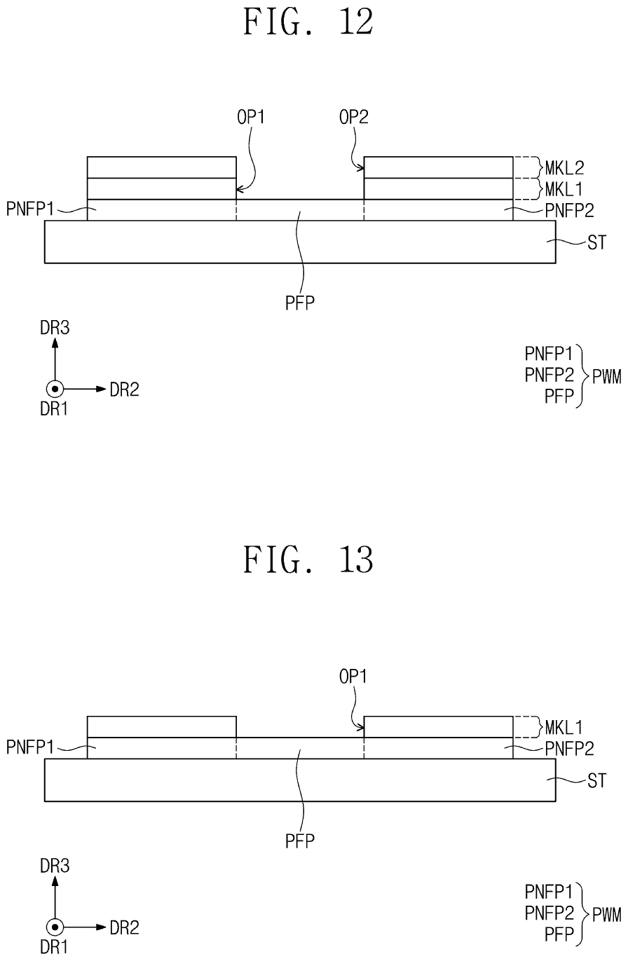

Referring to FIG. 12, the manufacturing method of the window may further include forming the first layer MKL1 between the forming of the second layer MKL2 and the forming of the window WM (refer to FIG. 15). In the forming of the first layer MKL1, the first etch portion ECA1 may be etched to form the first opening OP1. The etching of the first etch portion ECA1 may include coating the etching solution on the first etch portion ECA1. The preliminary folding portion PFP of the target substrate PWM may be exposed through the first opening OP1. Since the etching solution is coated through the second opening OP2 in the etching of the first etch portion ECA1, the size of the first opening OP1 in the plan view may be substantially the same as the size of the second opening OP2 in the plan view. The second layer MKL2 may be disposed directly on the first layer MKL1.

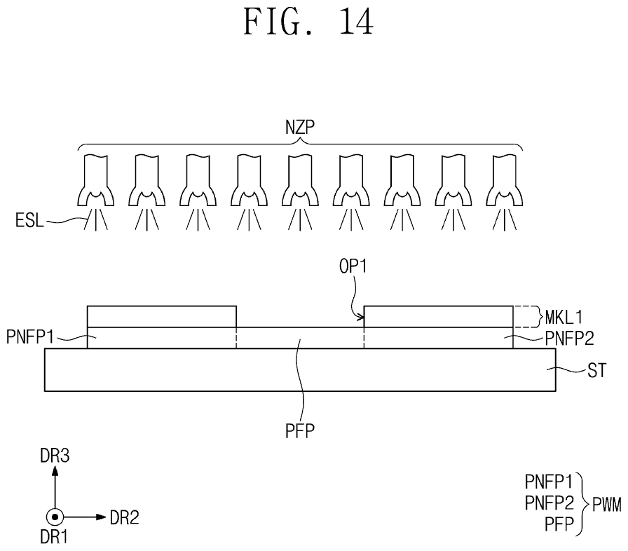

Referring to FIGS. 12 and 13, the manufacturing method of the window may further include removing the second layer MKL2 between the forming of the first layer MKL1 and the forming of the window WM (refer to FIG. 15). The removing of the second layer MKL2 may include the dry etch or wet etch process.

Referring to FIGS. 14 and 15, the window WM may be formed by spraying the etching solution ESL to the stage ST through the nozzle part NZP in the forming of the window WM. The etching solution ESL may be coated on each of the preliminary folding portion PFP of the target substrate PWM and the first layer MKL1 through the first opening OP1. The window WM may include the first non-folding portion NFP1, the second non-folding portion NFP2 spaced apart from the first non-folding portion NFP1 in the plan view, and the folding portion FP disposed between the first non-folding portion NFP1 and the second non-folding portion NFP2 in the plan view. The folding portion FP may have a thickness d1 smaller than a thickness d2 of the non-folding portions NFP1 and NFP2. The thickness d1 of the folding portion FP may be a minimum value obtained by measuring the thickness of the folding portion FP in the third directional axis DR3. A different between the thickness d1 of the folding portion FP and the thickness d2 of the non-folding portions NFP1 and NFP2 may be smaller than about 7 micrometers. The folding portion FP may include a flat surface PP and a slant surface SP. The flat surface PP may be substantially parallel to a plane defined by the first directional axis DR1 and the second directional axis DR2. The slant surface SP may be a surface connecting the flat surface PP and each of the first non-folding portion NFP1 and the second non-folding portion NFP2. The flat surface PP may have a width d3 equal to or greater than about 1 millimeter (mm) and equal to or smaller than about 25 mm in the plan view. In an embodiment, the width d3 of the flat surface PP in the plan view may be about 10 mm. An angle AG between the flat surface PP and the slant surface SP may be equal to or greater than about 0.1 degrees and smaller than about 0.4 degrees. In an embodiment, the angle AG between the flat surface PP and the slant surface SP may be about 0.2 degrees. A step difference between the flat surface PP and an upper surface of the first non-folding portion NFP1 or the second non-folding portion NFP2 may be equal to or greater than about 0.001 mm and equal to or smaller than about 0.007 mm. The step difference between the flat surface PP and the upper surface of the first non-folding portion NFP1 or the second non-folding portion NFP2 may be a difference between the thickness d2 of the non-folding portions NFP1 and NFP2 and the thickness d1 of the folding portion FP. In an embodiment, the step difference between the flat surface PP and the upper surface of the first non-folding portion NFP1 or the second non-folding portion NFP2 may be about 0.003 mm. The angle between the flat surface PP and the slant surface SP of the window WM manufactured by the manufacturing method according to the disclosure may be equal to or greater than about 0.1 degrees and equal to or smaller than about 0.4 degrees, and the angle between the flat surface PP and the slant surface SP of the window WM manufactured by the manufacturing method of the disclosure may be gentler than an angle between a flat surface and a slant surface of a conventional window. Accordingly, the image distortion occurring at a boundary between the folding area FA (refer to FIG. 1A) and the non-folding areas NFA1 and NFA2 (refer to FIG. 1A) of the display device ED (refer to FIG. 1A) may be improved.

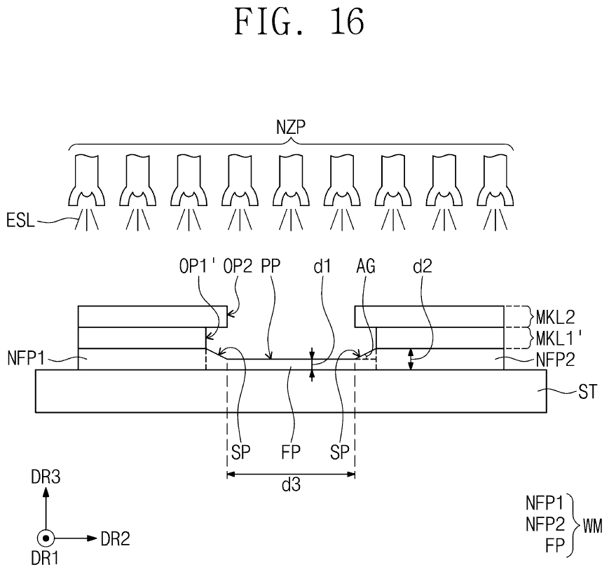

FIG. 16 illustrates a result of spraying an etching solution ESL on each of a portion of a preliminary first layer PMKL1, which is exposed through a second opening OP2, and a second layer MKL2 disposed on the preliminary first layer PMKL1 of FIG. 11.

Referring to FIGS. 11 and 16, a window WM may be formed by spraying the etching solution ESL to a stage ST in a state where the second layer MKL2 disposed on the preliminary first layer PMKL1 is not etched. The second layer MKL2 may include a material that is not etched by the etching solution ESL, and each of the preliminary first layer PMKL1 and a target substrate PWM may include a material that is etched by the etching solution ESL. Accordingly, when the etching solution ESL is sprayed, a portion of each of the preliminary first layer PMKL1 and the target substrate PWM may be etched by the etching solution ESL. The portion of the preliminary first layer PMKL1 may be etched by the etching solution ESL, and a first layer MKL1′ through which a first expansion opening OP1′ is defined may be formed. A size of the first expansion opening OP1′ may be greater than a size of the first opening OP1 of FIG. 14 in the plan view. The portion of the target substrate PWM may be etched by the etching solution ESL, and the window WM may be formed. Descriptions on the window WM shown in FIG. 15 may be applied to the window WM shown in FIG. 16. When the etching solution ESL is sprayed to the stage in the state where the second layer MKL2 disposed on the preliminary first layer PMKL1 is not removed, a portion of the second layer MKL2 overlapping a slant surface SP in the plan view may prevent the excessive application of the etching solution ESL on the slant surface SP, and thus, an angle between a flat surface PP and the slant surface SP may be equal to or greater than about 0.1 degrees and equal to or smaller than about 0.4 degrees. When the angle between the flat surface PP and the slant surface SP is smaller than about 0.1 degrees, the folding characteristics of the window WM may be deteriorated. When the angle between the flat surface PP and the slant surface SP is greater than about 0.4 degrees, the image distortion occurring at the folding area FA (refer to FIG. 1A) and the non-folding areas NFA1 and NFA2 (refer to FIG. 1A) of the display device ED (refer to FIG. 1A) may not be improved.

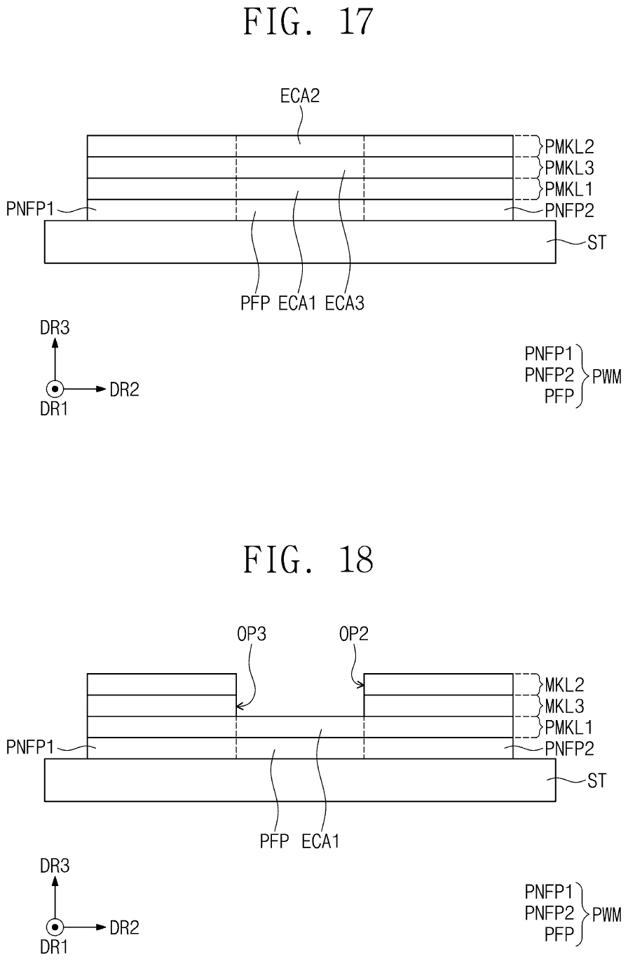

Referring to FIG. 17, the manufacturing method of the window may further include placing a preliminary third layer PMKL3 including a third etch portion ECA3 overlapping the target substrate PWM in the plane on the preliminary first layer PMKL1 between the placing of the preliminary first layer PMKL1 on the target substrate PWM and the placing of the preliminary second layer PMKL2 on the preliminary first layer PMKL1. The third etch portion ECA3 may overlap the second etch portion ECA2 in the plan view. The third etch portion ECA3 may overlap the first etch portion ECA1 in the plan view. The preliminary third layer PMKL3 may be disposed directly on the preliminary first layer PMKL1. The preliminary second layer PMKL2 may be disposed directly on the preliminary third layer PMKL3. The preliminary first layer PMKL1 may include the material etched by the etching solution ESL. The preliminary first layer PMKL1 may include a metal element. In an embodiment, the preliminary first layer PMKL1 may include titanium. The preliminary second layer PMKL2 may include the material that is not etched by the etching solution. The preliminary second layer PMKL2 may include the photoresist. The preliminary third layer PMKL3 may include the material etched by the etching solution ESL that further includes nitric acid. The preliminary third layer PMKL3 may include at least one of amorphous silicon and polysilicon. In an embodiment, the preliminary third layer PMKL3 may include amorphous silicon.

Referring to FIG. 18, according to the manufacturing method of the window, the forming of the second layer MKL2 may include etching the third etch portion ECA3 to form a third layer MKL3 through which a third opening OP3 is defined. The second etch portion ECA2 may be exposed through the third opening OP3. Then, the second layer MKL2 may be formed by etching the second etch portion ECA2. The second etch portion ECA2 and the third etch portion ECA3 may be substantially simultaneously etched. The second opening OP2 may overlap the third opening OP3 in the plan view. A size of the second opening OP2 in the plan view may be substantially the same as a size of the third opening OP3 in the plan view.

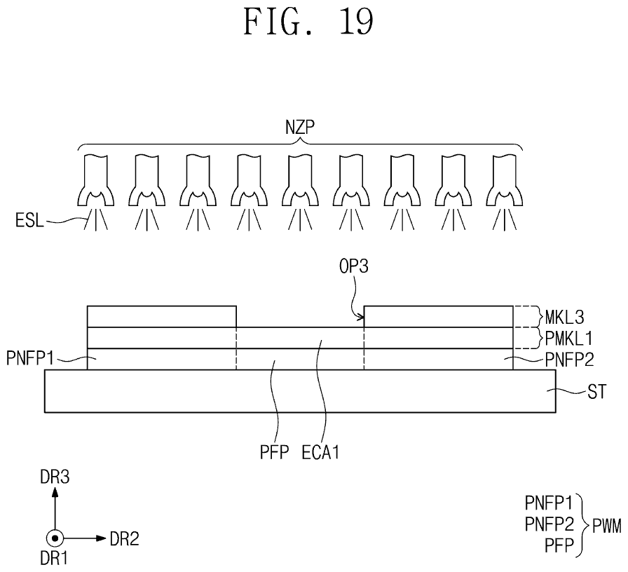

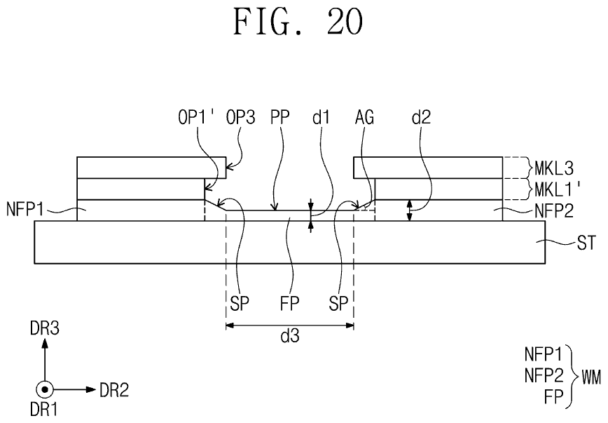

Referring to FIGS. 18 and 19, the manufacturing method of the window may include removing the second layer MKL2 between the forming of the second layer MKL2 and the forming of the window WM (refer to FIG. 20). The removing of the second layer MKL2 may include the dry etch or wet etch process. Since the third layer MKL3 includes at least one of amorphous silicon and polysilicon, an etch rate of the third layer MKL3 may be controlled by adjusting a concentration of nitric acid contained in the etching solution ESL. When the concentration of nitric acid contained in the etching solution ESL is excessively high, the etch rate of the third layer MKL3 may increase, and thus, the angle between the flat surface PP (refer to FIG. 20) and the slant surface SP (refer to FIG. 20) may be greater than about 0.4 degrees. When the concentration of nitric acid contained in the etching solution ESL is excessively low, the etch rate of the third layer MKL3 may decrease, and thus, the angle between the flat surface PP (refer to FIG. 20) and the slant surface SP (refer to FIG. 20) may be smaller than about 0.1 degrees.

Referring to FIGS. 19 and 20, the window WM may be formed by spraying the etching solution ESL to the third layer MKL3 and the first etch portion ECA1 exposed through the third opening OP3 through the nozzle part NZP. Descriptions on the window

WM shown in FIG. 15 may be applied to the window WM shown in FIG. 20.

According to the manufacturing method of the window, the window having the foldable characteristics and improved reliability may be manufactured through simplified process using the first layer including the material etched by the etching solution, and thus, the process difficulty may be improved.

Although the embodiments of the disclosure have been described, it is understood that the disclosure should not be limited to these embodiments but various changes and modifications may be made by one ordinary skilled in the art within the spirit and scope of the disclosure as hereinafter claimed. Therefore, the disclosed subject matter should not be limited to any single embodiment described herein, and the scope of the inventive concept shall be determined according to the attached claims.

What is claimed is:

1. An etching device comprising:
a stage on which a target substrate is disposed;
a nozzle part facing the stage with the target substrate interposed therebetween and spraying an etching solution toward the stage; and
a mask part disposed between the target substrate and the nozzle part, the mask part comprising:
a first layer provided with a first opening defined therethrough, the first layer comprising:
a material etched by the etching solution; and
a second layer disposed on the first layer and provided with a second opening which is defined therethrough and overlaps the first opening in a plan view.

2. The etching device of claim 1, wherein the etching solution comprises a fluorinated compound.

3. The etching device of claim 2, wherein the etching solution further comprises a nitric acid.

4. The etching device of claim 1, wherein the first layer comprises at least one of silicon oxide and a metal element, and the second layer comprises at least one of amorphous silicon and polysilicon.

5. The etching device of claim 4, wherein the first layer comprises titanium.

6. The etching device of claim 1, wherein the second opening completely penetrates through the second layer.

7. The etching device of claim 1, wherein the second opening has a size which is substantially equal to a size of the first opening in the plan view.

8. The etching device of claim 1, wherein the second layer is disposed directly on the first layer.

9. A method of manufacturing a window, the method comprising:
placing a target substrate on a stage;
placing a preliminary first layer comprising a first etch portion on the target substrate;
placing a preliminary second layer, which comprises a second etch portion overlapping the first etch portion in a plan view, on the preliminary first layer;
etching the second etch portion to form a second layer through which a second opening is defined to expose the first etch portion; and
spraying an etching solution toward the stage through a nozzle part disposed to face the stage with the target substrate interposed therebetween to form the window, wherein each of the preliminary first layer and the target substrate comprises a material etched by the etching solution.

10. The method of claim 9, further comprising etching the first etch portion to form a first layer through which a first opening is defined to expose a portion of the target substrate between the forming the second layer and the forming the window.

11. The method of claim 10, wherein the second opening has a size which is substantially equal to a size of the first opening in the plan view.

12. The method of claim 10, wherein the second layer is disposed directly on the first layer.

13. The method of claim 10, further comprising removing the second layer between the forming the first layer and the forming the window.

14. The method of claim 13, wherein the removing the second layer comprises a dry etch or wet etch process.

15. The method of claim 9, wherein the preliminary first layer comprises at least one of silicon oxide and a metal element, and the preliminary second layer comprises at least one of amorphous silicon and polysilicon.

16. The method of claim 9, further comprising placing a preliminary third layer comprising a third etch portion overlapping the target substrate in the plan view on the preliminary first layer between the placing the preliminary first layer on the target substrate and the placing the preliminary second layer on the preliminary first layer, wherein the forming the second layer comprises etching the third etch portion to form a third layer through which a third opening is defined to exposed the second etch portion, and the preliminary third layer is disposed between the preliminary first layer and the preliminary second layer.

17. The method of claim 16, further comprising removing the second layer between the forming the second layer and the forming the window.

18. The method of claim 16, wherein the preliminary first layer comprises titanium, the preliminary second layer comprises photoresist, and the preliminary third layer comprises at least one of amorphous silicon and polysilicon.

19. The method of claim 9, wherein the window comprises a first non-folding portion, a second non-folding portion spaced apart from the first non-folding portion in the plan view, and a folding portion disposed between the first non-folding portion and the second non-folding portion, and the folding portion has a thickness smaller than each of a thickness of the first non-folding portion and a thickness of the second non-folding portion.

20. The method of claim 19, wherein a difference between the thickness of the folding portion and each of the thickness of the first non-folding portion and the thickness of the second non-folding portion is smaller than about 7 micrometers.
